(19) United States
(12) Patent Application Publication
(10) Pub. No.: US 2013/0061528 A1
(43) Pub. Date: Mar. 14, 2013

(54) DOOR FRAME WITH A DEEP EMBOSS FOR HINGES AND METHOD OF MANUFACTURE OF A DOOR FRAME WITH A DEEP EMBOSS FOR HINGES

(71) Applicants: Don Verity, Pacoima, CA (US); Rick Griffis, Pacoima, CA (US)

(72) Inventors: Don Verity, Pacoima, CA (US); Rick Griffis, Pacoima, CA (US)

(21) Appl. No.: 13/230,773

(22) Filed: Sep. 12, 2011

(51) Int. Cl. E06B 3/34

(52) U.S. Cl. 49/398; 49/506

(57) ABSTRACT

The invention is a door frame made to accept deeper hinge embossing, and a method of manufacturing the same. The additional die cut stress holes are placed in locations to relieve stress on the door frame and to facilitate deeper hinge embossing. The additional die cut holes, which are not used for hinge screws, deform when the door frame is embossed.

### CROSS-REFERENCE TO RELATED APPLICATION

The present application claims priority to U.S. Provisional Patent Application Ser. No. 61/356,866, filed on Sep. 21, 2010, entitled, “Door Frame For Deep Emboss Hinges And Method Of Manufacturing Same,” by inventors Don Verity, Rick Griffis, and Robert H. Day, the contents of which are hereby incorporated by reference in their entirety herein.

### FIELD OF INVENTION

This invention generally relates to embossed, metal door frames. More specifically, the invention relates to an improved, embossed door frame apparatus and methods for manufacturing thereof.

### BACKGROUND

Doors are integral parts of a home, business, or other structure. They permit entry to and exit from a room and provide the occupant with a level of privacy. The most common type of door is a one-way hinge door, which is typically attached to an opening in a wall via hinges. The hinge attaches to the door and door frame by way of screws and other fasteners, and provides the door with limited rotation, allowing the occupant access into and out of a room. Because modern walls are often thin and hollow, screws and other fasteners cannot attach directly to the wall. As such, it is beneficial for the screws to attach to a door frame, which surrounds the opening in the wall. The two side pieces of the frame are typically called jambs, and the top piece, which goes overhead, is called a head. Door frames typically have a throat, two faces, two rabbets, a soffit, and two stops. The throat is the rear opening of a door frame that fits around the wall to which that piece of the door frame is attached. The face is the part of the door frame that runs parallel with the wall surfaces to which the door frame is attached. The rabbets and the soffit are at the end of the wall and are perpendicular to the door frame face. The soffit is the protruding section that typically runs the entire perimeter of the jambs and head. The soffit protrudes from the rabbets, which are on either side of the soffit. Each side of the protrusion is called a stop. The stops are perpendicular to the soffit and the two rabbets. The protruding soffit and the stops are what prevents the door from swinging straight through the opening. The rabbets are the typical portion of the door frame to which the hinges and strike plate are attached.

To ensure that the door may fit flush with the door frame when the door is closed, the hinge leaves and strike plate must be sunk into the door frame. This is typically accomplished by cutting out a portion of the rabbet at the attachment portion or stamp embossing the rabbet at the attachment portion.

The construction of the door frame varies, depending upon the location and application of the door. In homes, most door frames are constructed of wood, whereas industrial or commercial door frames are typically made of metal. To ensure that the door fits within the door frame and is flush against the frame, portions of the metal door frame can be embossed or cut in preparation of the door hinge laying flat within the frame. Because the hinge is typically screwed into the wall and door frame, screw holes are cut into the hinge attachment portion of the door frame. Previously, the only reason that a door frame was cut at the embossed location was to allow hinge screws to pass through the door frame to secure the hinge to the door frame and wall. A reinforcement bracket may be used to increase the support for the hinge screws.

The type of embossing done on the embossed hinge area also varies based upon the type of door to be used. The embossed hinge area can either accept light-weight or heavy-weight door hinges. Light-weight door hinges exist for door frames that have a low-volume of use, whereas heavy-weight door hinges exists for door frames that receive a high-volume of use. Heavy-weight hinges are typically larger and thicker than standard or light-weight hinges.

Because high traffic doorways use high-volume door frames and have heavy-weight hinges, the high-volume door frames are embossed or cut deeper than light-volume doorways. Unfortunately, the deeper the emboss, the more stress the door frame undergoes. The stress of a deep emboss causes the frame to warp and bend such that the door frame might not fit precisely with the hinge, door, wall, or other sections of the door frame.

To overcome problems of stress caused by a deep emboss, manufacturers typically cut the door frame at the hinge areas and weld the cut out pieces back in a deep and offset manner. Such a solution is detailed by U.S. Pat. No. 4,513,549, issued to Wendt, and U.S. Pat. No. 3,906,671, issued to Maldonado. However, the solution of cutting and welding is much more expensive, it requires post-painting and is much less efficient than merely embossing.

Thus, there remains a long felt need in the art for a metal door frame, and method of manufacturing a door frame, that provides for a deep emboss wherein the stress on the door frame from the deep emboss is minimized.

### SUMMARY OF THE INVENTION

Various embodiments of the invention are directed towards overcoming the deficiencies of the prior art and industry standards by providing an inexpensive and easy-to-manufacture embossed a door frame by cutting stress holes in the area to be embossed.

To minimize the limitations in the referenced inventions, and to minimize other limitations that will become apparent upon reading and understanding the present specification, the present invention discloses a metal door frame and method thereof, which includes one or more additional die cut holes that allow for deeper hinge emboss impressions with minimal stress to the door frame. In addition to the screw holes that accept hinge screws, additional stress holes are die cut into the door frame to reduce the stress on the door frame.

Another embodiment of the invention is a door frame comprising: a door frame; wherein the door frame is comprised of one or more hinge attachment portions; wherein the one or more hinge attachment portions are comprised of a plurality of attachment holes and one or more stress holes; and wherein the plurality of attachment holes are used to secure one or more hinges to the door frame. Preferably, the hinge attachment portions are embossed to create one or more embossed hinge attachment portions. Preferably, the one or more stress holes are substantially located within the one or more embossed hinge attachment portions. Preferably, the stress holes are deformed to minimize stress on the door frame when the one or more embossed hinge attachment portions are embossed. Preferably, the stress holes are comprised of one or more tabbed holes. The tabbed holes are comprised of an opening and a tab and the tab is angled proximally toward a throat of the door frame. The hinge attachment portions may be further comprised of one or more electrical holes.

Another embodiment of the invention is a method of manufacturing a door frame comprising the steps: providing a door frame; wherein the door frame is comprised of one or more hinge attachment portions; cutting a plurality of attachment holes into the door frame at the one or more hinge attachment portions; cutting one or more stress holes into the door frame at the one or more hinge attachment portions; and embossing the door frame at the one or more hinge attachment portions. Preferably, the stress holes reduce stress on the door frame when the door frame is embossed. Preferably, the stress holes are deformed when the door frame is embossed. Preferably, the one or more stress holes are comprised of one or more tabbed holes; wherein the one or more tabbed holes are created through the steps of cutting the one or more tabbed holes to create one or more tabs and angling the one or more tabs proximally toward a throat of the door frame. Preferably, the steps include cutting the one or more electrical holes into the door frame at the one or more hinge attachment portions.

One embodiment of the invention is a door frame, which comprises of: a door frame; one or more hinge attachment portions; a plurality of screw holes; and one or more stress holes. The door frame includes the one or more hinge attachment portions. The one or more hinge attachment portions also contain the plurality of screw holes. The plurality of screw holes secures a hinge of the door frame. The one or more hinge attachment portions contains the one or more stress holes, and the one or more stress holes do not secure a hinge to the door frame. Preferably, the one or more hinge attachment portions are embossed. Preferably, the one or more stress holes are substantially located within the one or more embossed hinge attachment portions. The one or more stress holes are typically deformed to minimize stress on the door frame. The one or more hinge attachment portions are typically more than 135/1000-inches from a surface of the one or more embossed hinge attachment portions. The one or more stress holes generally include one or more tabs, and the one or more tabs are created by a punched hole. The punched hole creates a cut portion in the one or more tabs, and the cut portion is not substantially removed from the door frame. The one or more hinge attachment portions may have one or more electrical holes. Preferably, the door frame is made of metal.

Another embodiment of the present invention is a door frame, comprising: a throat; one or more rabbets; and one or more embossed hinge attachment portions. The throat substantially fits around a corner of a wall. The one or more rabbets substantially prevent a door from swinging through a door frame; the one or more embossed hinge attachment portions are substantially positioned within the one or more rabbets; and the one or more embossed hinge attachment portions contain a plurality of screw holes and one or more stress holes. Preferably, the door frame further comprises of: a soffit and one or more stops. The soffit and the one or more stops further assist the one or more rabbets to prevent the door from swinging through the door frame. Preferably, the one or more embossed hinge attachment portions are more than 135/1000-inches from a surface of the one or more embossed hinge attachment portions. Typically, the one or more stress holes are substantially positioned within one or more embossed hinge attachment portions. Typically, the one or more stress holes are deformed to minimize stress on the door frame. The one or more stress holes may include one or more tabs, and the one or more tabs are created by a punched hole. The punched hole creates a cut portion in the one or more tabs, and the cut portion is not substantially removed from the door frame.

Another embodiment of the present invention is a method of manufacturing a door frame, which comprises the steps of: providing a door frame with one or more hinge attachment portions and embossing one or more hinge attachment portions into the door frame. The one or more hinge attachment portions include a plurality of screw holes and one or more stress holes. Preferably, the one or more stress holes are substantially located in areas to reduce stress on the door frame when the door frame is embossed. Preferably, the one or more stress holes are deformed during embossing to minimize stress on the door frame. The method may further comprise of: an embossed stencil and a plurality of screw holes. The embossed stencil is substantially aligned with both the plurality of screw holes and the one or more stress holes. Preferably, the door frame is painted during the manufacturing process. Preferably, the one or more stress holes do not accept one or more screws and the plurality of screw holes do not substantially deform under pressure during an embossing process.

In one embodiment, one or more stress holes include one or more tabs, wherein the one or more tabs are created by a punched hole in the door frame. However, the cut portion may not be fully removed from the door frame without deviating from the scope of the invention.

It is an object of the invention to provide a metal embossed door frame. Alternatively, the door frame may be made out of any natural or man-made material such as wood or plastic, without deviating from the scope of the invention.

It is an object of the present invention to provide a strong, affordable, efficient, and easy to construct embossed door frame that overcomes the limitations of the prior art. Embossed frames are less expensive than cut frames, because the cut-out portions of the door frame need to be reattached through an expensive welding process. This welding process is also very inefficient. Additionally, painting embossed door frames can be completed during the initial manufacturing process. Cut- and weld-type metal door frames, however, are typically painted on-site after the manufacturing process. Having to paint the door frame away from the controlled environment of the original manufacturing plant is more expensive and inefficient.

It is another object of the present invention to improve the fitting of a heavier door to a door frame. Because manufacturers expect highly-used door frames to use heavy-weight hinges, such door frames are embossed deeper than light-volume doorways. This allows the heavy-weight hinge to be flushed against the rest of the door frame. Unfortunately, door frames undergo more stress with a deeper emboss impression. However, the present invention of the improved, embossed, metal door frame is manufactured with a plurality of die-cut holes to accept and deform under the embossing stress. By having die cut stress holes, relinquishment of embossing stress and deformation will occur, thereby maintaining the door frame's integrity.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a detailed illustration of a perspective view of one embodiment of the hinge attachment portion of a door frame before embossing.

FIG. 2 is a detailed illustration of a perspective view of one embodiment of the hinge attachment portion of a door frame after embossing.

FIG. 3 is a detailed illustration of a front plan view of one embodiment of the hinge attachment portion of a door frame before embossing.

FIG. 4 is a detailed illustration of a front plan view of one embodiment of the hinge attachment portion of a door frame after embossing.

### DETAILED DESCRIPTION OF THE DRAWINGS

In the following detailed description of the preferred embodiment, reference is made to the accompanying drawings that form a part thereof, and in which is shown, by way of illustration, a specific embodiment in which the invention may be practiced. It is to be understood that other embodiments may be utilized, and structural changes may be made without departing from the scope of the present invention.

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

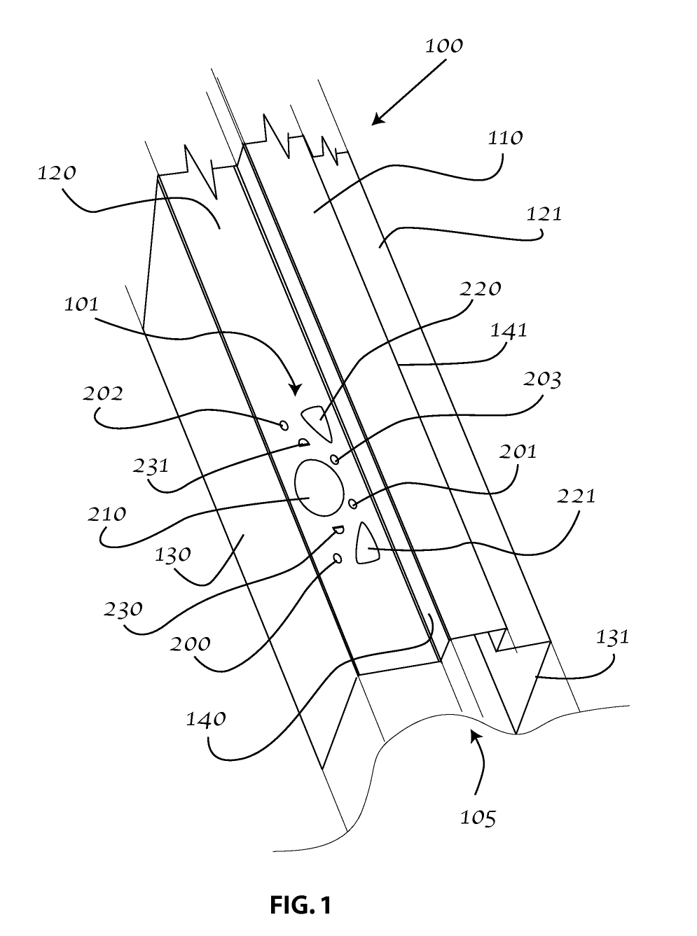

FIG. 1 is a detailed illustration of a perspective view of one embodiment of the hinge attachment portion of a door frame before embossing. As shown in FIG. 1, the door frame 100 is preferably comprised of hinge attachment portion 101, throat 105, soffit 110, rabbets 120 and 121, faces 130 and 131, and stops 140 and 141. FIG. 1 also shows how hinge attachment portion 101 preferably has attachment holes 200, 201, 202, 203, stress holes 220, 221, tabbed holes 230, 231, and electrical hole 210. Although a specific number of holes are shown in FIG. 1, it should be understood that any number of holes may be present without deviating from the scope of the invention. Preferably, the holes are die cut into door frame 100. As shown in FIG. 1, the attachment portion 101, which is preferably one of several very similar attachment portions on door frame 100, is on rabbet 120 of door frame 100. The rabbets 120 and 121 may be equal or unequal in width without deviating from the scope of the invention.

Door frame 100 is typically made of aluminum or some other metal, but it may be made of any material that can be embossed, included composite materials, wood, or any natural or man-made material, without deviating from the scope of the invention. Door frame 100 is typically placed at the end of a wall, at an opening in the wall. The throat 105 goes around the end of the wall. Attachment holes 200, 201, 202, 203 are preferably used to allow a screw, nail, or other attachment device to pass through door frame 100 in order to connect a hinge to the end of the wall that door frame 100 has been placed. Before the present invention door frame hinge attachment portions only included attachment holes. No other holes were cut into the hinge attachment portions. Stress holes 220, 221 are cut into the hinge attachment portion 101 so that when hinge attachment portion 101 is embossed, or punched down, to make room for a hinge, the metal or other material at hinge attachment portion 101 is not overly stressed by the embossing process. Depending on how deep the emboss will be, and a very deep emboss is required for a heavy-duty door and heavy-duty door hinge, the metal in the embossed area will deform and be stressed. If the door frame 100 is over stressed, it might not be suitable to fit with the door and the hinge.

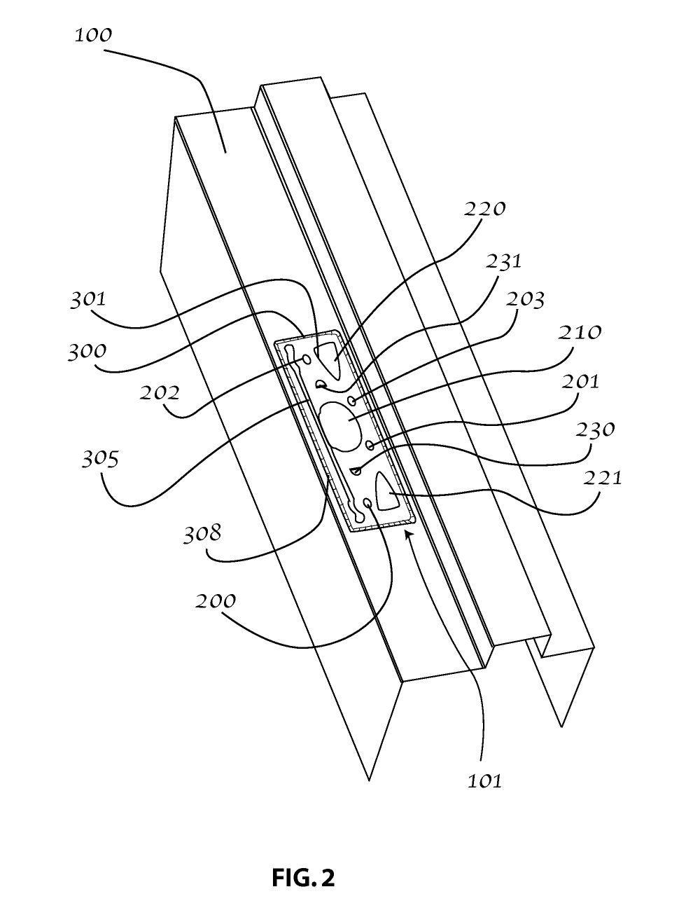

FIG. 2 is a detailed illustration of a perspective view of one embodiment of the hinge attachment portion of a door frame after embossing. FIG. 2 shows how hinge attachment portion 101 preferably has attachment holes 200, 201, 202, 203, stress holes 220, 221, tabbed holes 230, 231, electrical hole 210, embossed sides 300, embossed area 301, emboss groove 305, and emboss lip 308. FIG. 2 shows the hinge attachment portion 101 after a very deep embossing, in order to fit a heavy-duty hinge and door onto door frame 100. FIG. 2 shows how attachment holes 200, 201, 202, 203, and embossed area 301 have not been deformed or otherwise over stressed during the embossing process because of the presence of stress holes 220, 221. FIG. 2 shows that during the embossing process, stress holes 220, 221, which are designed and situated within attachment portion 101 to deform and stretch during embossing, deform and stretch during embossing. The deformation of stress holes 220, 221, relieve stress on embossed area 301 and prevent stress on door frame 100. Tabbed holes 230, 231, which are preferably comprised of an opening and a tab that is bent down toward throat 105, are used to secure a threaded hinge reinforcement plate to the back of the door frame 100. FIG. 2 shows that stress holes 220, 221 are triangular and tabbed holes 230, 231 are semi-circular, as preferred, but other shapes may be used without deviating from the scope of the invention. Additionally, although stress holes 220, 221 and tabbed holes 230, 231 are shown in FIG. 2 in their preferred location and are used to secure a threaded hinge reinforcement plate to the back of the door frame 100. Tabbed holes 230, 231 may be located in other areas without deviating from the scope of the invention. The tabs of tabbed holes 230, 231, as shown in FIG. 2 protrude from the door frame 100 and are used to secure a threaded hinge reinforcement plate to the back of the door frame 100.

FIG. 2 also shows the optional electrical hole 210, which might serve as a passage way for wires to travel from the wall, through the door frame 100, and to the door or another part of the door frame 100. Because most hinges have rectangular leafs, the embossed area 301 is, as shown in FIG. 2, preferably rectangular. But, embossed area 301 may be any shape.

Without the stress holes 220, 221, a deep emboss, such as about 180/1000-inches, to fit a heavy-weight hinge, as opposed to the standard or light weight hinge, which only requires an emboss depth of about 135/1000-inch from the surface, would cause tremendous stress on embossed area 301.

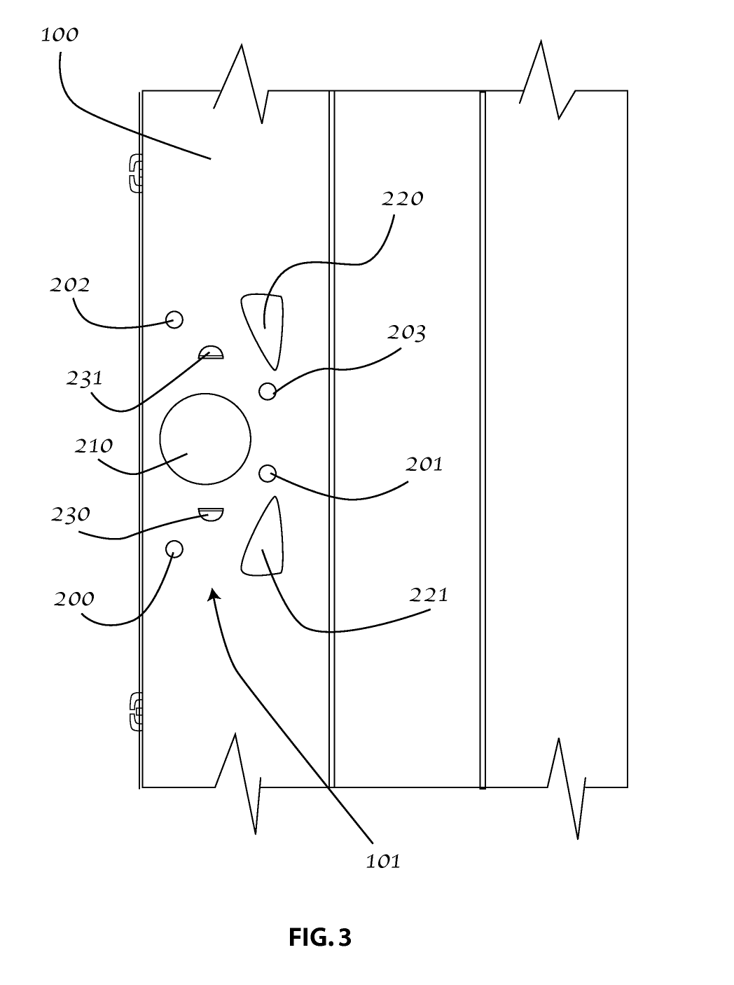

FIG. 3 is a detailed illustration of a front view of one embodiment of the hinge attachment portion of a door frame before embossing. FIG. 3 also shows how hinge attachment portion 101 preferably has attachment holes 200, 201, 202, 203, stress holes 220, 221, tabbed holes 230, 231, and electrical hole 210. FIG. 3 shows how all of the holes are preferably within hinge attachment portion 101. In this manner stress holes 220, 221 can provide the most relief to hinge attachment portion 101 when hinge attachment portion 101 is embossed.

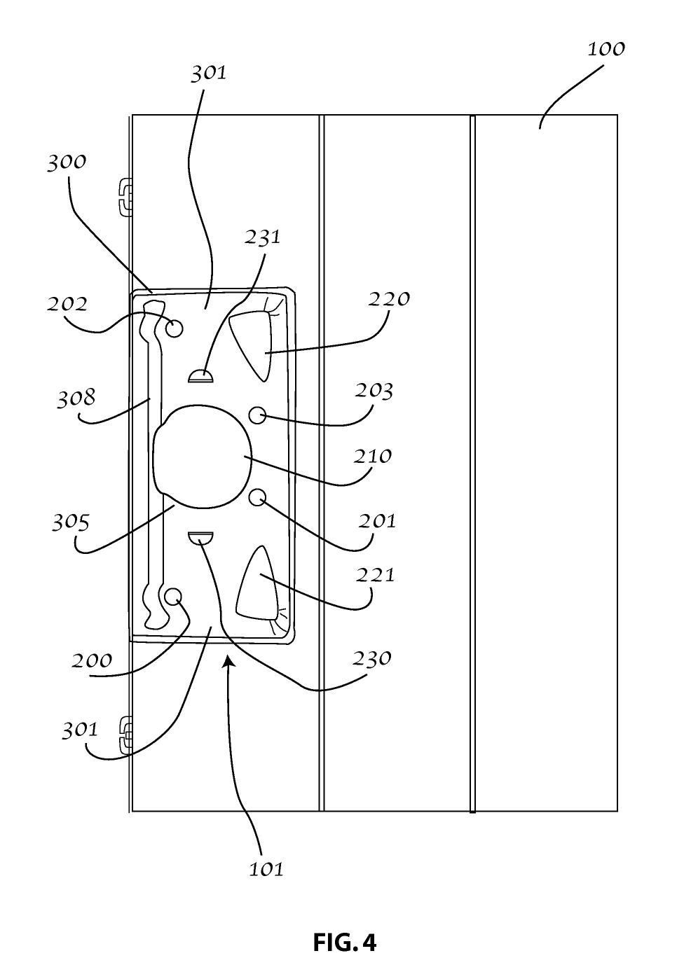

FIG. 4 is a detailed illustration of a front view of one embodiment of the hinge attachment portion of a door frame after embossing. FIG. 4 shows how hinge attachment portion 101 preferably has attachment holes 200, 201, 202, 203, stress holes 220, 221, tabbed holes 230, 231, electrical hole 210, embossed sides 300, embossed area 301, emboss groove 305, and emboss lip 308. The emboss groove 305, preferably provides extra stability and room within embossed area 301.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A door frame comprising:
a door frame;
wherein said door frame is comprised of one or more hinge attachment portions;
wherein said one or more hinge attachment portions are comprised of a plurality of attachment holes and one or more stress holes;
wherein said plurality of attachment holes are used to secure one or more hinges to said door frame.

2. The door frame of claim 1, wherein said one or more hinge attachment portions are embossed to create one or more embossed hinge attachment portions.

3. The door frame of claim 2, wherein said one or more stress holes are substantially located within said one or more embossed hinge attachment portions.

4. The door frame of claim 3, wherein said one or more stress holes are deformed to minimize stress on said door frame when said one or more embossed hinge attachment portions are embossed.

5. The door frame of claim 4, wherein said one or more stress holes are comprised of one or more tabbed holes;
wherein said one or more tabbed holes are comprised of an opening and a tab;
wherein said tab is angled proximally toward a throat of said door frame.

6. The door frame of claim 4, wherein said one or more hinge attachment portions are further comprised of one or more electrical holes.

7. A door frame comprising:
a door frame;
wherein said door frame is comprised of one or more hinge attachment portions;
wherein said one or more hinge attachment portions are comprised of a plurality of attachment holes, one or more stress holes, one or more tabbed holes, and one or more electrical holes;
wherein said plurality of attachment holes are used to secure one or more hinges to said door frame;
wherein said one or more hinge attachment portions are embossed to create one or more embossed hinge attachment portions;
wherein said plurality of attachment holes, said one or more stress holes, said one or more tabbed holes, and said one or more electrical holes are substantially located within said one or more embossed hinge attachment portions;
wherein said one or more stress holes are deformed to minimize stress on said door frame when said one or more embossed hinge attachment portions are embossed;
wherein said one or more tabbed holes are comprised of an opening and a tab;
wherein said tab is angled proximally toward a throat of said door frame.

8. A method of manufacturing a door frame comprising the steps:
providing a door frame;
wherein said door frame is comprised of one or more hinge attachment portions;
cutting a plurality of attachment holes into said door frame at said one or more hinge attachment portions;
cutting one or more stress holes into said door frame at said one or more hinge attachment portions;
embossing said door frame at said one or more hinge attachment portions.

9. The method of manufacturing a door frame of claim 8, wherein said one or more stress holes reduce stress on said door frame when said door frame is embossed.

10. The method of manufacturing a door frame of claim 9, wherein said one or more stress holes are deformed when said door frame is embossed.

11. The method of manufacturing a door frame of claim 10, wherein said one or more stress holes are comprised of one or more tabbed holes;
wherein said one or more tabbed holes are created through the steps of cutting said one or more tabbed holes to create one or more tabs and angling said one or more tabs proximally toward a throat of said door frame.

12. The method of manufacturing a door frame of claim 10, further comprising the steps of:
cutting said one or more electrical holes into said door frame at said one or more hinge attachment portions.
